(19) United States
(12) Patent Application Publication
(10) Pub. No.: US 2022/0043901 A1
(43) Pub. Date: Feb. 10, 2022

(54) METHOD OF DATA TRANSFER BETWEEN HOSTED APPLICATIONS

(71) Applicant: Shanghai Lianshang Network Technology Co., Ltd., Shanghai (CN)

(72) Inventor: Yinglin Cui, Shanghai (CN)

(73) Assignee: Shanghai Lianshang Network Technology Co., Ltd.

(21) Appl. No.: 17/452,389

(22) Filed: Oct. 26, 2021

Related U.S. Application Data
(63) Continuation of application No. PCT/CN2020/085548, filed on Apr. 20, 2020.

(30) Foreign Application Priority Data
Apr. 26, 2019 (CN) 201910345874.3

(51) Int. Cl. G06F 21/44; G06F 3/06

(52) U.S. Cl. CPC G06F 21/44; G06F 3/0673; G06F 3/0659; G06F 3/0622

(57) ABSTRACT

A method of data transfer between hosted applications. The method comprises: establishing a shared storage area for a first hosted application: locking access permissions to the shared storage area (S11); receiving and authenticating a data access request for the shared storage area for the first hosted application transmitted by a second hosted application; accepting the access request if the authentication is passed; and denying the access request if the authentication fails (S12).

### CROSS REFERENCE TO THE RELATED APPLICATION

This application is the continuation application of International Application No. PCT/CN2020/085548, filed on Apr. 20, 2020, which is based upon and claims priority to Chinese Patent Application No. 201910345874.3, filed on Apr. 26, 2019, the entire contents of which are incorporated herein by reference.

### TECHNICAL HELD

The present application relates to internet applications, and more particularly relates to a method of data transfer between hosted applications.

### BACKGROUND

Currently, hosted applications are provided in some APPs (Applications). Hosted applications may be easily accessed and delivered within a host application without installation and uninstallation, and may provide excellent use experience. Hosted applications may provide convenient and rich services such as booking, product purchase, games, etc. However, due to independence of hosted applications, only one hosted application may be running at a time. Thus, real-time data sharing between different hosted applications cannot be achieved, and even non-real-time data sharing is difficult.

### SUMMARY

Various aspects of the present application provide a method of data transfer between hosted applications to solve a problem that data interaction between different hosted applications cannot be achieved.

In an aspect of the present application, a method of data transfer between hosted applications is provided. The method is implemented at a host application and comprises: establishing a shared storage area for a first hosted application; locking access permissions to the shared storage area; receiving a data access request for the shared storage area for the first hosted application transmitted by a second hosted application, authenticating permission for the second hosted application; accepting the access request if the authentication is passed; and denying the access request if the authentication fans.

In another aspect of the present application, a method of data transfer between hosted applications is provided. The method is implemented at a first hosted application and comprises: transmitting an invocation instruction, wherein the invocation instruction is used to instruct a second hosted application to read data in a shared storage area for the first hosted application; and receiving an execution result returned by the second hosted application after accessing the shared storage area for the first hosted application and forwarded by a host application.

In another aspect of the present application, a method of data transfer between hosted applications is provided. The method is implemented at a second hosted application and comprises: receiving an invocation instruction transmitted by a first hosted application and forwarded by a host application, wherein the invocation instruction is used to instruct the second hosted application to read data in a shared storage area for the first hosted application; and transmitting an access request for the data in the shared storage area for the first hosted application to the host application so that the host application authenticates permission for the second hosted application.

In another aspect of the present application, a device is provided. The device comprises: one or more processors; storage means for storing one or more programs. The one or more programs, when executed by the one or more processors, cause the one or more processors to implement any one of the methods described above.

In another aspect of the present application, a computer readable storage medium storing computer programs thereon is provided. The computer programs, when executed by a processor, implement any one of the methods described above.

As can be seen from the described technical solution, data access between hosted applications may be realized in the above-described embodiments of the present application.

### DESCRIPTIONS OF THE DRAWINGS

In order to explain technical solutions in embodiments of the present application more clearly, drawings required to be used in the descriptions of embodiments or in the prior art will be briefly introduced below. Obviously, the drawings described below are some embodiments of the present application. For any person of ordinary skills in the art, other drawings may also be obtained according to these drawings without paying creative labor.

FIG. 1 is a schematic flowchart of a method of data transfer between hosted applications implemented at a host application provided in some embodiments of the present application;

FIG. 2 is a schematic flowchart of a method of data transfer between hosted applications implemented at a first hosted application provided in some embodiments of the present application;

FIG. 3 is a schematic flowchart of a method of data transfer between hosted applications implemented at a second hosted application provided in some embodiments of the present application; and

FIG. 4 is a block diagram of an exemplary computer system/server suitable for use in implementing some embodiments of the present disclosure.

### DETAILED EMBODIMENTS

To explain objects, technical solutions, and advantages of some embodiments of the present application more clearly, the technical solutions in the embodiments of the present application will be described clearly and fully in connection with the accompanying drawings in the embodiments of the present application below. Obviously, the described embodiments are parts of the embodiments, but not all of the embodiments of the present application. Based on the embodiments in the present application, all other embodiments obtained by any person of ordinary skills in the art without paying creative labor fall within the protection scope of the present application.

In addition, the term “and/or” herein only refers to an association relationship which describes associated objects, and represents that there may be three relationships. For example, A and/or B may represent three situations: A exists alone, A and B exist at the same time, or B exists alone. In addition, the character “I” in this document generally represents that the associated objects before and after the character are in an “or” relationship,

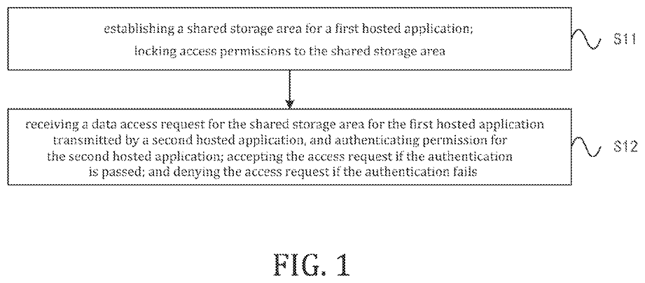

FIG. 1 is a schematic flowchart of a method of data transfer between hosted applications provided in some embodiments of the present application. The method is implemented at a host application and comprises the following steps:

step S11: establishing a shared storage area for a first hosted application; locking access permissions to the shared storage area; and

step S12: receiving a data access request for the shared storage area for the first hosted application transmitted by a second hosted application, and authenticating permission for the second hosted application; accepting the access request if the authentication is passed; and denying the access request if the authentication fails.

In some embodiments, the host application is an application (APP) client installed on a wireless device, such as WeChat, or the operating system of the wireless device. The hosted application is an application which runs with dependence on a host application, such as an applet in WeChat etc.

The wireless device is a host, which includes but is not limited to any type of smart terminal devices capable of human-machine interaction with users and implementing wireless communication functions, such as smart phones, tablets, laptops, etc. Of course, the wireless device may also be other devices with similar functions. This embodiment is not limited thereto. The smart terminal devices can adopt any operating system, such as Android operating system, iOS operating system, Windows operating system, etc.

In a embodiment of step S11,

the host application initiates the first hosted application in response to triggering, by a user, the first hosted application.

For example, the host application initiates a default running stack and runs the first hosted application on the default running stack. The host application establishes the shared storage area for the first hosted application before, at the same time when or after the host application initiates the first hosted application.

For example, the shared storage area is located in storage space of the host. For example, the shared storage area may be configured in a Random Access Memory (RAM) of the host, may be configured in a Read Only Memory (ROM) of the host, or may be configured in both RAM and ROM.

For example, due to the sandbox provided by the operating system of the host, each of the hosted applications has its own corresponding sandbox, and each of the sandboxes is independent from each other and cannot be accessed by each other. Thus, the shared storage area may be configured in data directories of the ROM of the host to prevent cracking.

For example, due to memory capacity limitation of the host, especially the capacity limitation of the RAM, the size of the shared storage area needs to be configured in advance, to avoid affecting normal operations of the operating system of the host. For example, the host application divides the storage space of the host into storage areas, and allocates to each hosted application a start address and an end address of its shared storage area in the divided storage areas respectively.

For example, the shared storage area is permission control enabled. For example, the shared storage area is locked with an authorization ID of the first hosted application. By locking the shared storage area, it is possible that no restriction is placed on read and write operations by the first hosted application on the shared storage area while authentication is required for read and write operations by other hosted applications on the shared storage area.

For example, the host application receives permission information set by the first hosted application and stores the permission information locally. Alternatively, the host application receives permission information set by the user and stores the permission information locally.

For example, the permission information comprises permissions separately set for individual hosted applications. The individual hosted application is identified through its AppID.

In practical applications, messages are forwarded between hosted applications by the host application, facilitating the interaction between the hosted applications. However, some data of the hosted applications themselves, such as pictures, videos, audios, etc. cannot be forwarded simply by the host application. Thus a shared storage area may be established to achieve transfer of the above data.

In a preferred implementation of step S12,

the host application receives an access request for the shared storage area for the first hosted application from the second hosted application and authenticates permission for the second hosted application.

For example, the second hosted application generates the access request for the shared storage area for the first hosted application according to data portion of the invocation instruction. The data portion of the invocation instruction may be a read instruction which instructs the second hosted application to read data in the shared data area for the first hosted application to enable data transfer between the first hosted application and the second hosted application.

For example, the host application authenticates access permission for the second hosted application. If the authentication is passed, the access request is allowed. If the authentication fails, the access request is denied, and a message such as authentication failure is returned to the second hosted application.

For example, the host application verifies the access request against permission information stored in advance according to identity information (e.g. an APPID, an access public key) comprised in the access request transmitted by the second hosted application.

For example, the host application intercepts the message transmitted by the second hosted application, determines whether it is an access request. If it is an access request, the host application authenticates the access permission for the second hosted application. If it is not an access request, the host application proceeds normally.

For example, the host application receives the access request transmitted from the second hosted application via a preset API interface, and authenticates access permission for the second hosted application, so that the second hosted application accesses the shared storage area for the first hosted application via the API interface.

For example, after successful authentication, the second hosted application reads the data in the shared data area for the first hosted application. The second hosted application returns an execution result of executing the invocation instruction to the first hosted application.

For example, the host application receives an execution result returned by the second hosted application after accessing the shared storage area for the first hosted application, and returns the execution result to the first hosted application.

For example, before receiving the data access request to the shared storage area for the first hosted application transmitted by the second hosted application, the method further comprises the following steps:

receiving an invocation instruction transmitted by the first hosted application, and forwarding the invocation instruction to the second hosted application, wherein the invocation instruction is used to instruct the second hosted application to read data in the shared storage area for the first hosted application; and

preferably running the second hosted application on an auxiliary running stack according to the invocation instruction transmitted by the first hosted application, forwarding the invocation instruction to the second hosted application.

For example, the host application receives the invocation instruction transmitted by the first hosted application. The invocation instruction comprises identification information of the second hosted application. The invocation instruction is used to instruct the second hosted application to read data in the shared storage area for the first hosted application.

The invocation instruction has a structure as follows comprising an instruction header, a separator and data.

For example, the instruction header portion is used to mark the second hosted application so that the host application runs the second hosted application. For example, the instruction header is the AppID of the second hosted application. Different hosted applications are identified by their AppIDs.

For example, the data portion of the invocation instruction may be a read instruction which instructs to read data in the shared data area for the first hosted application to enable data transfer between the first hosted application and the second hosted application.

For example, the read instruction comprises the AppID of the first hosted application and the address of the data to be read.

For example, the host application initiates an auxiliary running stack according to the invocation instruction. The auxiliary running stack is used by the host application to run the second hosted application while the first hosted application is being run on the default running stack. For example, the host application is able to initiate one or more auxiliary running stacks in order to run individual hosted applications in one or more auxiliary running stacks respectively. That is, instant messaging between multiple hosted applications may be achieved.

For example, after the auxiliary running stack is initiated, the second hosted application marked by the invocation instruction is run on the auxiliary running stack.

For example, after receipt of the invocation instruction, the host application checks whether there is a corresponding second hosted application running on the auxiliary running stack according to the AppID comprised in the invocation instruction.

If the corresponding second hosted application is already being run on the auxiliary running stack, the invocation instruction may be forwarded to the second hosted application so that the second hosted application executes the invocation instruction.

If there is no corresponding second hosted application running on the auxiliary running stack, an auxiliary running stack is initiated so that the second hosted application is run in the auxiliary running stack. The invocation instruction is forwarded to the second hosted application so that the second hosted application executes the invocation instruction.

In a preferred embodiment of the present application, after completion of the invocation, the host application terminates the hosted application, empties rather than destroys the auxiliary running stack, and may run any desired hosted application on the auxiliary running stack quickly.

For example, if the second hosted application is not initiated, it is determined whether there is an initiated and emptied auxiliary running stack. If yes, the second hosted application is run directly on the auxiliary running stack. If not, an auxiliary running stack is initiated so that the second hosted application may be run on the auxiliary running stack.

For example, the host application invokes the second hosted application in the background, i.e. an interface of the first hosted application remains unchanged.

The host application forwards the invocation instruction to the second hosted application so that the second hosted application executes the invocation instruction.

For example, in a preferred embodiment of the present application,

the host application establishes a shared storage area for the first hosted application and only configures its owner, i.e. the corresponding hosted application with read and write permission and configures the second hosted application with only read permission. Therefore, since the second hosted application can only read data of the first hosted application, and cannot modify the data of the first hosted application, interaction between the second hosted application and the first hosted application cannot be achieved, although data security of the first hosted application is ensured.

For bidirectional communication between the first hosted application and the second hosted application, the first hosted application and the second hosted application are required to access each other's shared storage area respectively.

For example, the hosted application establishes the shared storage area for the second hosted application according to the invocation instruction transmitted by the first hosted application, before, at the same time when or after running the second hosted application runs on the auxiliary running stack.

The second hosted application accesses data in the shared storage area for the first hosted application via the access request: writes the accessed data into the shared storage area for the second hosted application. The second hosted application processes the data written into the shared storage area for the second hosted application and saves a result of processing.

For example, the second hosted application transmits a feedback message to the first hosted application so that the first hosted application transmits an access request for the shared storage area for the second hosted application to the host application according to the feedback message. After authentication is passed by the host application, the first hosted application reads the corresponding processed data stored in the shared storage area for the second hosted application and stores the processed data in the shared storage area for the first hosted application itself.

The method as described in this embodiment enables the second hosted application to access data of the first hosted application, and further enables bidirectional data interaction between the first hosted application and the second hosted application.

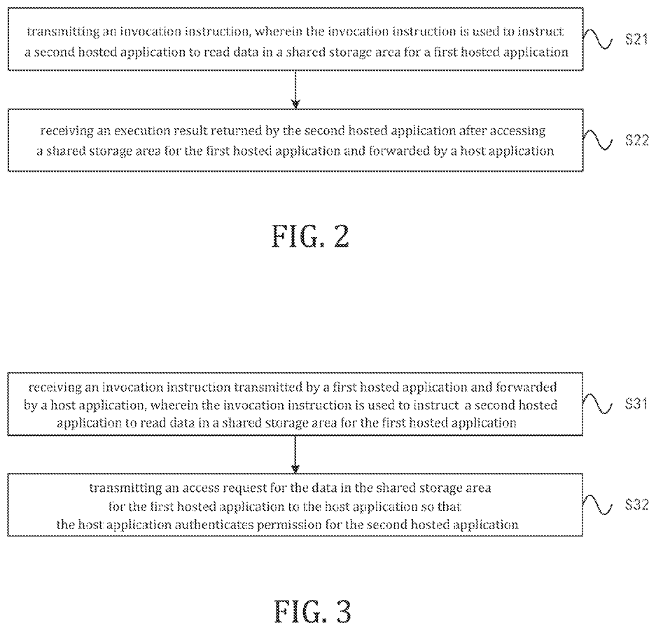

FIG. 2 is a schematic flowchart of a method of data transfer between hosted applications provided in some embodiments of the present application. The method is implemented at a first hosted application and comprises the following steps:

step S21: transmitting an invocation instruction, wherein the invocation instruction is used to instruct a second hosted application to read data in a shared storage area for the first hosted application: and

step S22: receiving an execution result returned by the second hosted application after accessing the shared storage area for the first hosted application and forwarded by a host application.

In a preferred implementation of step S21,

For example, the first hosted application is initiated by the host application. The host application initiates a default running stack and runs the first hosted application on the default running stack. The host application establishes the shared storage area for the first hosted application before, at the same time when or after the host application initiates the first hosted application.

For example, the shared storage area is permission control enabled. For example, the shared storage area is locked with an authorization ID of the first hosted application. By locking the shared storage area, it is possible that no restriction is placed on read and write operations by the first hosted application on the shared storage area while authentication is required for read and write operations by other hosted applications on the shared storage area.

For example, the host application receives permission information set by the first hosted application and stores the permission information locally. Alternatively, the host application receives permission information set by the user and stores the permission information locally.

For example, the permission information comprises permissions separately set for individual hosted applications. The individual hosted application is identified through its AppID.

For example, the first hosted application transmits an invocation instruction. The invocation instruction is used to instruct the second hosted application to read data in the shared storage area for the first hosted application.

The host application runs the second hosted application on an auxiliary running stack according to the invocation instruction transmitted by the first hosted application, and forwards the invocation instruction to the second hosted application.

Specifics of the step may be made reference to the corresponding section of the aforementioned embodiments, and details will not be described herein again.

In a preferred implementation of step S22,

the host application receives an access request for the shared storage area for the first hosted application from the second hosted application.

For example, the host application authenticates access permission for the second hosted application. If the authentication is passed, the access request is allowed. If the authentication fans, the access request is denied, and a message such as authentication failure is returned to the second hosted application.

For example, after successful authentication, the second hosted application reads the data in the shared data area for the first hosted application.

For example, the second hosted application returns an execution result of executing the read instruction to the first hosted application.

For example, the host application receives an execution result returned by the second hosted application after accessing the shared storage area for the first hosted application and returns the execution result to the first hosted application.

The first hosted application receives an execution result returned by the second hosted application after accessing the shared storage area for the first hosted application and forwarded by the host application.

Specifics of the step may be made reference to the corresponding section of the aforementioned embodiments, and details will not be described herein again.

In a preferred implementation of this embodiment,

for bidirectional communication between the first hosted application and the second hosted application, the first hosted application and the second hosted application are required to access each others shared storage area respectively.

For example, the host application establishes the shared storage area for the second hosted application according to the invocation instruction transmitted by the first hosted application, before, at the same time when or after running the second hosted application on the auxiliary running stack.

The second hosted application accesses data in the shared storage area for the first hosted application via the access request, and writes the accessed data into the shared storage area for the second hosted application. The second hosted application processes the data written into the shared storage area for the second hosted application and saves a result of processing.

For example, the second hosted application transmits a second invocation instruction to the first hosted application. The second invocation instruction is used to instruct the first hosted application to read data in the shared storage area for the second hosted application.

For example, the host application forwards the second invocation instruction to the first hosted application. The first hosted application receives the second invocation instruction and transmits an access request for the shared storage area for the second hosted application to the host application according to the second invocation instruction, so that the host application authenticates the access request. The first hosted application accesses data in the shared storage area for the second hosted application after the authentication is passed.

After the authentication is passed, the first hosted application reads corresponding processed data stored in the shared storage area for the second hosted application, and stores the processed data in the shared storage area for the first hosted application itself.

For example, the first hosted application returns an execution result of executing the read instruction to the second hosted application. The execution result is received by the host application and returned to the second hosted application.

The method as described in this embodiment enables the second hosted application to access data of the first hosted application, and further enables bidirectional data interaction between the first hosted application and the second hosted application.

FIG. 3 is a schematic flowchart of a method of data transfer between hosted applications provided in some embodiments of the present application. The method is implemented at a second hosted application and comprises the following steps:

step 31: receiving an invocation instruction transmitted by a first hosted application and forwarded by a host application, wherein the invocation instruction is used to instruct the second hosted application to read data hi the shared storage area for the first hosted application: and

step S32: transmitting an access request for the data in the shared storage area for the first hosted application to the host application so that the host application authenticates permission for the second hosted application: and accessing the data in the shared storage area for the first hosted application after the authentication is passed.

In a preferred implementation of step S31,

the host application receives an invocation instruction transmitted by the first hosted application. The invocation instruction is used to instruct the second hosted application to read data in the shared storage area for the first hosted application.

For example, the host application initiates an auxiliary running stack according to the invocation instruction. The auxiliary running stack is used by the host application to run the second hosted application while the first hosted application is being run on the default running stack.

The host application forwards the invocation instruction to the second hosted application so that the second hosted application executes the invocation instruction.

Specifics of the step may be made reference to the corresponding section of the aforementioned embodiments, and details will not be described herein again.

In a preferred implementation of step S32,

For example, the second hosted application generates an access request for the shared storage area for the first hosted application according to the invocation instruction.

For example, the host application authenticates access permission for the second hosted application. If the authentication is passed, the access request is allowed. If the authentication fans, the access request is denied, and a message such as authentication failure is returned to the second hosted application.

For example, after successful authentication, the second hosted application reads the data in the shared data area for the first hosted application.

For example, the second hosted application returns an execution result of executing the read instruction to the first hosted application.

For example, the execution result is received by the host application and returned to the first hosted application.

Specifics of the step may be made reference to the corresponding section of the aforementioned embodiments, and details will not be described herein again.

In a preferred implementation of this embodiment, for bidirectional communication between the first hosted application and the second hosted application, the first hosted application and the second hosted application are required to access each other's shared storage area respectively.

The second hosted application accesses data in the shared storage area for the first hosted application via the access request, and writes the accessed data into the shared storage area for the second hosted application. The second hosted application processes the data written into the shared storage area for the second hosted application and saves a result of processing.

For example, the second hosted application transmits a second invocation instruction to the first hosted application. The second invocation instruction is used to instruct the first hosted application to read data in the shared storage area for the second hosted application.

For example, the host application forwards the second invocation instruction to the first hosted application. The first hosted application receives the second invocation instruction and transmits an access request for the shared storage area for the second hosted application to the host application according to the second invocation instruction, so that the host application authenticates the access request. After the authentication is passed, the first hosted application reads corresponding processed data stored in the shared storage area for the second hosted application, and stores the processed data in the shared storage area for the first hosted application itself.

For example, the first hosted application returns an execution result of executing the read instruction to the second hosted application. The execution result is received by the host application and returned to the second hosted application.

For example, the second hosted application receives the execution result forwarded by the host application.

The method as described in this embodiment enables the second hosted application to access data of the first hosted application, and further enables bidirectional data interaction between the first hosted application and the second hosted application.

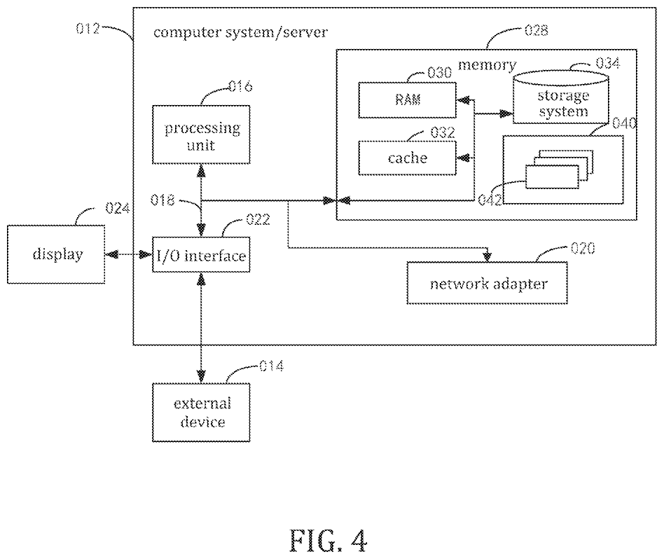

FIG. 4 shows a block diagram of an exemplary computer system/server 012 suitable for implementing the embodiments of the present disclosure. The computer system/server 012 shown in FIG. 4 is merely an example, and should not impose any limitation on the functions and scope of use of the embodiments of the present disclosure.

As shown in FIG. 4, the computer system/server 012 is embodied as a general-purpose computing device. Components of the computer system/server 012 may include but are not limited to one or more processors or processing units 016, a system memory 028, a bus 018 connecting different system components (including the system memory 028 and the processing unit 016).

The bus 018 represents one or more of several types of bus structures, including a memory bus or a memory controller, a peripheral bus, a graphics acceleration port, a processor, or a local area bus using any of a variety of bus structures. By way of example, these architectures include, but are not limited to, an Industry Standard Architecture (ISA) bus, a Micro Channel Architecture (MAC) bus, an enhanced ISA bus, a Video Electronics Standards Association (VESA) local area bus, and a peripheral component interconnect (PCI) bus.

Computer system/server 012 typically includes a variety of computer system readable media. These media can be any available media that can be accessed by the computer system/server 012, including volatile and non-volatile media, removable and non-removable media.

The system memory 028 may include computer system readable media in the form of a volatile memory, such as a random access memory (RAM) 030 and/or a cache memory 032. Computer system/server 012 may further include other removable/non-removable, volatile/nonvolatile computer system storage media. By way of example only, the storage system 034 may be used to read and write non-removable, non-volatile magnetic media (not shown in FIG. 4 and is commonly referred to as a “hard drive”). Although not shown in FIG. 4, a magnetic disk drive for reading and writing to a removable non-volatile magnetic disk (for example, “a floppy disk”) and an optical disk drive for reading and writing to a removable non-volatile optical disk (for example, CD-ROM, DVD-ROM or other optical media) may be provided. In these cases, each drive may be connected to the bus 018 through one or more data media interfaces. The memory 028 may include at least one program product having a set of (e.g., at least one) program modules configured to perform the functions of the embodiments of the present disclosure.

A program/utility tool 040 having a set of (at least one) program modules 042 may be stored in, for example, the memory 028. Such program modules 042 include, but are not limited to, operating system, one or more hosted applications, other programs modules and program data, each one of or some combination of these examples may include implementations of the network environment. The program module 042 generally performs functions and/or methods in the embodiments described in the present disclosure.

The computer system/server 012 can also communicate with one or more external devices 014 (e.g., a keyboard, a pointing device, a display 024, etc.). In the present disclosure, the computer system/server 012 can communicate with external radar devices, and can also communicate with one or more devices that enable users to interact with the computer system/server 012, and/or with any device (such as a network card, a modem, etc.) that enables the computer system/server 012 to communicate with one or more other computing devices. Such communication can be performed through an input/output (I/O) interface 022. Moreover, the computer system/server 012 can also communicate with one or more networks (such as a local area network (LAN), a wide area network (WAN), and/or a public network, such as the Internet) through a network adapter 020. As shown in FIG. 4, the network adapter 020 communicates with other modules of the computer system/server 012 through the bus 018. It should be understood that although not shown in FIG. 4, other hardware and/or software modules may be used in conjunction with the computer system/server 012, including but not limited to: microcode, device drivers, redundant processing units, external disk drive arrays, RAID systems, tape drives and data backup storage systems.

The processing unit 016 executes programs stored in the system memory 028 to execute the functions and/or methods in the embodiments described in the present disclosure.

The above-mentioned computer programs may be set in computer storage media, that is, the computer storage media are encoded with computer programs, which when executed by one or more computers, causes the one or more computers to execute the method flows and/or apparatus operations shown in the above-described embodiments of the present disclosure.

With the development of time and technology, the meaning of media has become more and more extensive. The propagation method of computer programs is no longer limited to tangible media, Computer programs can also be downloaded directly from the network. Any combination of one or more computer-readable media may be used. The computer-readable media may be computer-readable signal media or computer-readable storage media. The computer-readable storage media may be, for example, but not limited to, an electronic, magnetic, optical, electromagnetic, infrared, or semiconductor system, apparatus, or device, or any combination thereof. More specific examples (non-exhaustive list) of computer-readable storage media may include: electrical connections with one or more wires, portable computer magnetic disks, hard disks, a random access memory (RAM), a read-only memory (ROM), an erasable programming read-only memory (EPROM or flash memory), an optical fiber, a portable compact disk read-only memory (CD-ROM), an optical storage device, a magnetic storage device, or any suitable combination of the foregoing. In the present document, the computer-readable storage media may be any tangible media that contain or store programs that can be used by or in combination with an instruction execution system, apparatus, or device.

Computer-readable signal media may include a data signal that is included in a baseband or propagated as part of a carrier wave, and which carries computer-readable program code, Such a propagated data signal may take many forms, including but not limited to electromagnetic signals, optical signals, or any suitable combination of the foregoing. The computer-readable signal media may also be any computer-readable media other than computer-readable storage media, and the computer-readable media may send, propagate, or transmit a program for use by or in connection with an instruction execution system, apparatus or device.

Program code embodied on computer-readable media may be transmitted using any appropriate media, including but not limited to: wireless, wired, optical fiber cable, RF, etc., or any suitable combination of the foregoing.

Computer program code for performing the operations of the present disclosure may be written in one or more programming languages, or a combination thereof, including object oriented programming languages such as Java, Smalltalk, C++, and conventional procedural programming language, such as “C” or similar programming language. The program code can be executed entirely on the user's computer, partly on the user's computer, as an independent software package, partly on the user's computer and partly on a remote computer, or entirely on a remote computer or server. In the case of a remote computer, the remote computer can be connected to the user's computer through any kind of network, including a local area network (LAN) or wide area network (WAN), or it can be connected to an external computer (for example through Internet connection provided by an Internet service provider).

Finally, it should be noted that the above embodiments are merely used to illustrate the technical solutions of the present application, not to limit them; although the present application has been described in detail with reference to the foregoing embodiments, persons of ordinary skill in the art should understand that they can modify the technical solutions described in the foregoing embodiments, or equivalently replace some of the technical features; and these modifications or replacements do not deviate from the spirit and scope of the technical solutions of the embodiments of the present application.

What is claimed is:

1. A method, implemented at a host application, of data transfer between hosted applications, comprising:
establishing a shared storage area for a first hosted application; locking access permissions to the shared storage area;
receiving a data access request for the shared storage area for the first hosted application transmitted by a second hosted application, authenticating permission for the second hosted application; and
accepting the access request if the authentication is passed; denying the access request if the authentication fans.

2. The method as recited in daim 1, wherein the establishing the shared storage area for the first hosted application comprising:
initiating a default running stack and running the first hosted application on the default running stack; and
establishing the shared storage area for the first hosted application before, at the same time when or after running the first hosted application.

3. The method as recited in claim 2, wherein the locking the access permissions to the shared storage area comprising:
storing identity information of hosted applications with access permissions to the shared storage area in advance.

4. The method as recited in claim 3, wherein the locking the access permissions to the shared storage area further comprising: configuring the first hosted application with read and write permission and configuring the second hosted application with read permission.

5. The method as recited in claim 1, wherein before receiving the data access request for the shared storage area for the first hosted application transmitted by the second hosted application, the method further comprising:
receiving an invocation instruction transmitted by the first hosted application, and forwarding the invocation instruction to the second hosted application, wherein the invocation instruction is used to instruct the second hosted application to read data in the shared storage area for the first hosted application.

6. The method as recited in claim 5, wherein the forwarding the invocation instruction to the second hosted application according to the invocation instruction transmitted by the first hosted application comprising:
running the second hosted application on an auxiliary running stack, and forwarding the invocation instruction to the second hosted application.

7. The method as recited in claim 3, wherein the receiving the data access request for the shared storage area for the first hosted application transmitted by the second hosted application and the authenticating comprising:
verifying the data access request against the permission information stored in advance according to the identity information comprised in the data access request.

8. The method of claim 1, wherein the method further comprising:
receiving an execution result returned by the second hosted application after accessing the shared storage area for the first hosted application; returning the execution result to the first hosted application.

9. The method as recited in claim 6, wherein the running the second hosted application on the auxiliary running stack, and forwarding the invocation instruction to the second hosted application further comprising:
establishing a shared storage area for the second hosted application before, at the same time when or after running the second hosted application.

10. The method as recited in claim 9, wherein the method further comprising:
receiving a data access request for the shared storage area for the second hosted application transmitted by the first hosted application, and authenticating permission for the first hosted application; accepting the access request if the authentication is passed; and denying the access request if the authentication fails.

11. A device, comprising:
one or more processors; and
a storage means for storing one or more programs,
wherein the one or more programs, when executed by the one or more processors, cause the one or more processors to:
establish a shared storage area for a first hosted application; locking access permissions to the shared storage area;
receive a data access request for the shared storage area for the first hosted application transmitted by a second hosted application, authenticating permission for the second hosted application; and
accept the access request if the authentication is passed; denying the access request if the authentication fails.

12. A computer readable storage medium storing computer programs thereon, the computer programs, when executed by a processor, cause the processor to:
establish a shared storage area for a first hosted application; locking access permissions to the shared storage area;
receive a data access request for the shared storage area for the first hosted application transmitted by a second hosted application, authenticating permission for the second hosted application; and
accept the access request if the authentication is passed; denying the access request if the authentication fails.
